(19) United States
(12) Patent Application Publication
(10) Pub. No.: US 2007/0223391 A1
(43) Pub. Date: Sep. 27, 2007

(54) Packet transmission system

(75) Inventors: Yuji Kuroki, Fukuoka (JP); Koji Hachiya, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/488,076

(22) Filed: Jul. 18, 2006

(30) Foreign Application Priority Data
Mar. 22, 2006 (JP) 2006-079040

(51) Int. Cl. H04J 1/16

(52) U.S. Cl. 370/252; 370/392

(57) ABSTRACT

A packet transmission system by which the occurrence of an overflow or an underflow can be prevented and by which a packet interval at a sending end can be reproduced with great accuracy at a receiving end. A packet gap extraction section extracts a packet gap from a packet stream. A packet gap measurement section measures the packet gap and generates gap information. A packet data with gap information sending section sends packet data with gap information. A packet gap insertion section inserts a packet gap adjusted on the basis of a gap adjustment value into the packet data to be buffered. A buffer monitoring section monitors buffer use of a packet buffer and generates the gap adjustment value used for narrowing the packet gap in the case of the buffer use being greater than an overflow detection threshold or used for widening the packet gap in the case of the buffer use being smaller than an underflow detection threshold.

### CROSS-REFERENCE TO RELATED APPLICATIONS

This application is based upon and claims the benefits of priority from the prior Japanese Patent Application No. 2006-079040, filed on Mar. 22, 2006, the entire contents of which are incorporated herein by reference.

### BACKGROUND OF THE INVENTION

1. Field of the Invention

This invention relates to a packet transmission system and, more particularly, to a packet transmission system for transmitting a packet including idle data (dead data).

2. Description of the Related Art

The moving picture experts group (MPEG) system is widely used as a technique for compressing video signals or audio data. To send or receive data processed with the MPEG system via a transmission line, the digital video broadcasting-asynchronous serial interface (DVB-ASI) is proposed. With the DVB-ASI, a plurality of packets coded with the MPEG system are multiplexed to generate a transport stream (TS). By inserting idle data (packet gap), being dead data, into an interval where actual data does not exist, output speed is kept constant and transmission is performed.

With the DVB-ASI, standard timing information is used for reproducing the original video or audio from the TS. This timing information is referred to as a program clock reference (PCR).

If an interval between PCRs at a sending end differs from an interval between PCRs at a receiving end, then synchronization is not established properly at the receiving end, resulting in distortion of video or audio. Accordingly, it is necessary that an interval between PCRs at the sending end should match an interval between PCRs at the receiving end.

Conventionally, a packet transmission technique in which the number of idle packets between PCRs is counted and in which a PCR interval is transferred to a receiving end by transmitting that number is proposed (see, for example, Japanese Patent Laid-Open Publication No. 2001-308876, paragraphs [0028]-[0035] and FIG. 1).

In addition, a technique in which sending time information for a packet generated from a sending-end clock is sent and in which coded data is reproduced at a receiving end on the basis of the sending time information is proposed (see, for example, Japanese Patent Laid-Open Publication No. 2004-104701, paragraphs [0038]-[0067] and FIG. 1).

With the above conventional technique disclosed in Japanese Patent Laid-Open Publication No. 2001-308876, information for a packet interval at the sending and receiving ends can be reproduced. However, deviation between a clock in a sending-end unit and a clock in a receiving-end unit is not taken into consideration, so an overflow or an underflow occurs in a receiving buffer.

Furthermore, with the above conventional technique disclosed in Japanese Patent Laid-Open Publication No. 2004-104701, information for a packet interval is reproduced by using the sending time information. A clock which can change a frequency on the output side by voltage control is used for eliminating deviation between a clock in a sending-end unit and a clock in a receiving-end unit. As a result, a frequency on the output side is controlled and the occurrence of an overflow or an underflow is prevented. However, a voltage control crystal oscillator (VCXO) which can change a clock frequency is expensive and is difficult to control. Accordingly, this technique is not the best solution.

### SUMMARY OF THE INVENTION

The present invention was made under the background circumstances described above. An object of the present invention is to provide a packet transmission system that prevents the occurrence of an overflow or an underflow and that performs high-quality packet transmission by reproducing a sending-end packet interval at a receiving end with great accuracy.

In order to achieve the above object, a packet transmission system for transmitting a packet is provided. This packet transmission system comprises a packet sending unit including a packet gap extraction section for extracting a packet gap from a packet stream in which packet data is multiplexed, a packet gap measurement section for measuring the packet gap extracted and for generating gap information which is a measured value, and a packet data with gap information sending section for adding the gap information to the packet data and for generating and sending packet data with gap information; and a packet receiving unit including a packet data with gap information separation section for receiving the packet data with gap information and for separating the gap information from the packet data, a packet gap insertion section for inserting a packet gap adjusted on the basis of a gap adjustment value into the packet data to be buffered, a packet buffer for storing the packet data and the packet gap inserted, and a buffer monitoring section for monitoring buffer use of the packet buffer and for generating the gap adjustment value used for narrowing the packet gap in the case of the buffer use being greater than an overflow detection threshold or used for widening the packet gap in the case of the buffer use being smaller than an underflow detection threshold.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the principles underlying a packet transmission system.

FIG. 2 shows a digital video transmission system.

FIG. 3 shows the transmission format of a DVB-ASI signal.

FIG. 4 shows the operation of a packet sending unit.

FIG. 5 shows the operation of a packet receiving unit.

FIG. 6 shows the operation of the packet receiving unit.

FIG. 7 shows the structure of a packet transmission system.

FIG. 8 shows the position of timing information.

FIG. 9 shows the operation of a packet sending unit.

FIG. 10 shows the operation of a packet receiving unit.

FIG. 11 shows the operation of the packet receiving unit.

### DESCRIPTION OF THE PREFERRED EMBODIMENTS

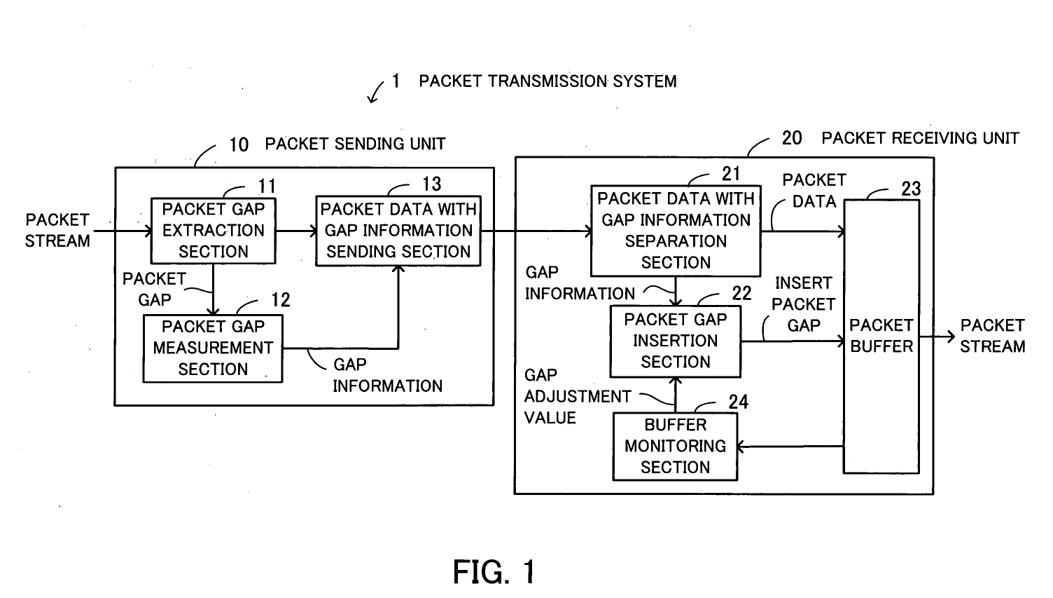

Embodiments of the present invention will now be described with reference to the drawings. FIG. 1 is a view for describing the principles underlying a packet transmission system. A packet transmission system 1 according to a first embodiment of the present invention comprises a packet sending unit 10 and a packet receiving unit 20 and performs packet transmission by informing a receiving end of a sending-end packet interval.

The packet sending unit 10 includes a packet gap extraction section 11, a packet gap measurement section 12, and a packet data with gap information sending section 13. The packet gap extraction section 11 extracts a packet gap (idle data, that is to say, an interval where actual data does not exist) from a packet stream in which packet data is multiplexed.

The packet gap measurement section 12 measures the packet gap extracted and generates gap information which is a measured value. To be concrete, the packet gap measurement section 12 counts the number of bytes corresponding to the data length of the packet gap. That is to say, the packet gap measurement section 12 counts the number of bytes included in an interval where packet data does not exist. This count is the gap information. The packet data with gap information sending section 13 adds the gap information to the packet data and generates and sends packet data with gap information.

The packet receiving unit 20 includes a packet data with gap information separation section 21, a packet gap insertion section 22, a packet buffer 23, and a buffer monitoring section 24.

The packet data with gap information separation section 21 receives the packet data with gap information and separates the gap information from the packet data. The packet gap insertion section 22 inserts a packet gap adjusted on the basis of a gap adjustment value into the packet data to be buffered in the packet buffer 23.

The packet buffer 23 stores the packet data and the packet gap inserted by the packet gap insertion section 22. The buffer monitoring section 24 monitors buffer use of the packet buffer 23. If the buffer use is greater than an overflow detection threshold, then the buffer monitoring section 24 generates the gap adjustment value for narrowing the packet gap. If the buffer use is smaller than an underflow detection threshold, then the buffer monitoring section 24 generates the gap adjustment value for widening the packet gap.

When the capacity of a buffer is greater than an overflow detection threshold which is determined in advance, an overflow is considered to have occurred in the buffer. When the capacity of a buffer is smaller than an underflow detection threshold which is determined in advance, an underflow is considered to have occurred in the buffer.

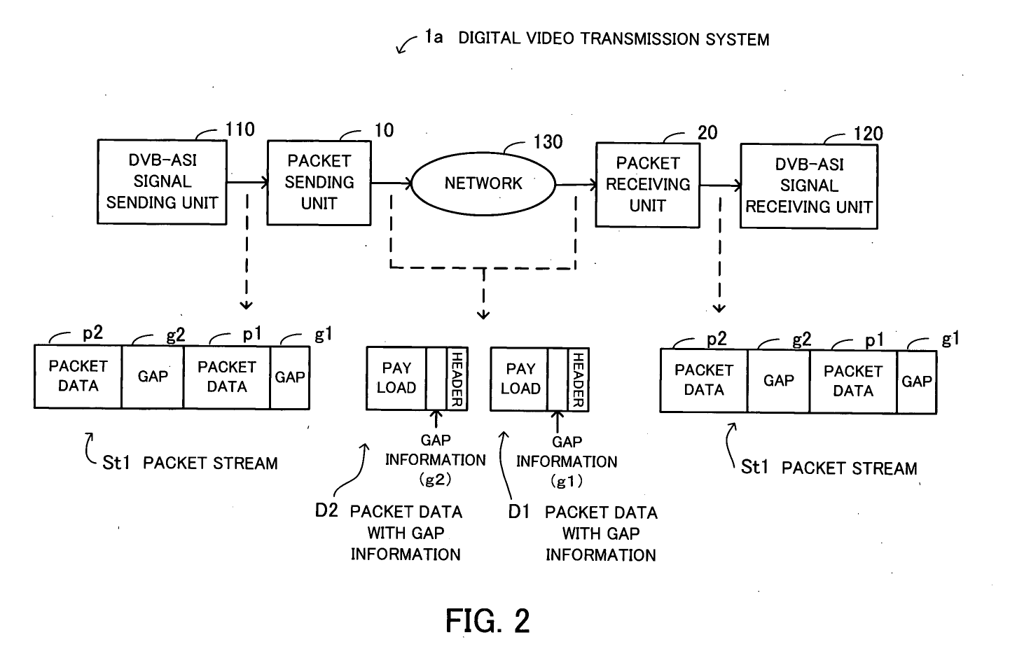

An example to which the present invention is applied will now be described. FIG. 2 shows a digital video transmission system. A digital video transmission system 1a comprises a DVB-ASI signal sending unit 110, a packet sending unit 10, a packet receiving unit 20, a DVB-ASI signal receiving unit 120, and a network 130.

The DVB-ASI signal sending unit 110 sends a packet stream (hereinafter also stated as TS) including a packet gap. The packet sending unit 10 receives the packet stream, performs the processes described in FIG. 1, generates packet data with gap information, and outputs it to the network 130.

The packet receiving unit 20 receives the packet data with gap information via the network 130, performs the processes described in FIG. 1, generates a packet stream in which a sending-end packet interval is reproduced, and sends the packet stream to the DVB-ASI signal receiving unit 120.

It is assumed that a packet stream St1 in which a packet gap g1 is before packet data p1 and in which a packet gap g2 is before packet data p2 is outputted from the DVB-ASI signal sending unit 110 (packet gaps g1 and g2 differ in length).

When the packet sending unit 10 receives the packet stream St1, the packet sending unit 10 generates packet data with gap information D1 by adding gap information (g1) which is the number of bytes corresponding to the packet gap g1 to the packet data p1, generates packet data with gap information D2 by adding gap information (g2) which is the number of bytes corresponding to the packet gap g2 to the packet data p2, and sends the packet data with gap information D1 and the packet data with gap information D2 via the network 130.

Packet data includes a header and a payload. Gap information is inserted, for example, between the header and the payload to generate packet data with gap information (gap information may be inserted into a free area in the header or a specific place in the payload if it can be detected at the receiving end).

When the packet receiving unit 20 receives the packet data with gap information D1 and the packet data with gap information D2, the packet receiving unit 20 reproduces the original packet stream St1 on the basis of the gap information (g1), the gap information (g2), and a gap adjustment value described later.

The transmission format of a DVB-ASI signal will now be described. Two modes of TS transmission are available in the DVB-ASI system: packet mode and burst mode.

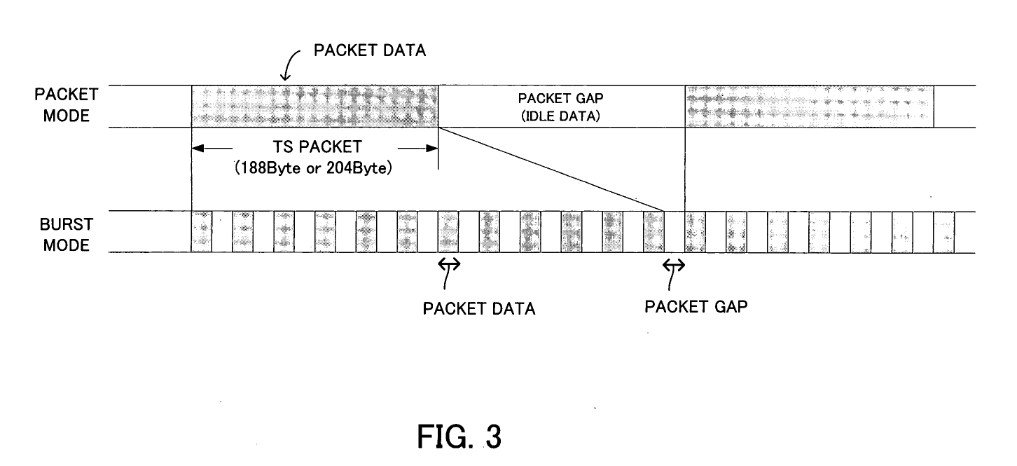

FIG. 3 shows the transmission format of a DVB-ASI signal. In the packet mode, a TS packet (188 or 204 bytes) is transmitted in block and does not include a packet gap (idle data). In the burst mode, a packet including a packet gap is transmitted. In FIG. 3, a piece of packet data is divided into twelve pieces of packet data. A packet gap is inserted between two pieces of packet data and a total of eleven packet gaps are inserted.

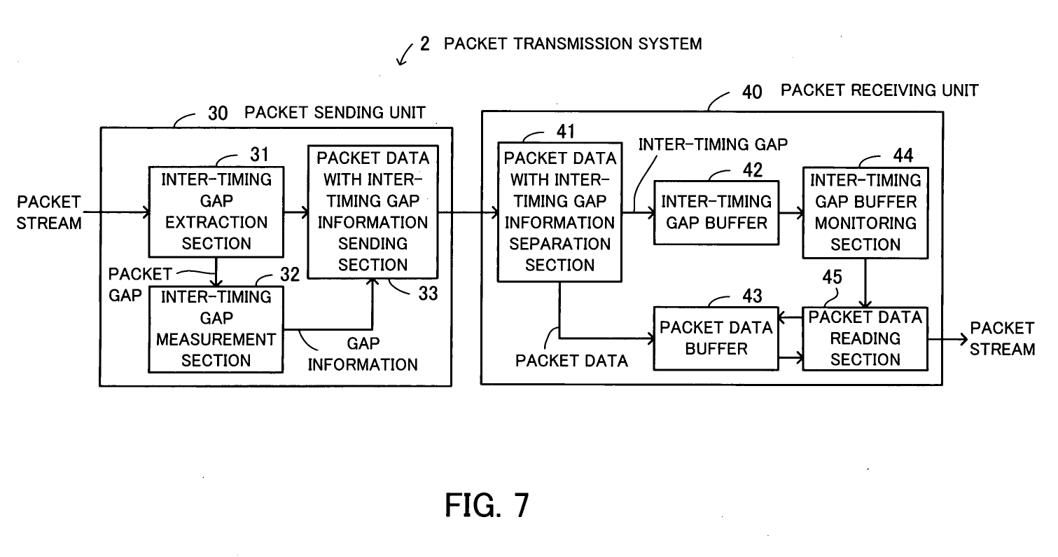

The packet transmission system 1 according to the first embodiment of the present invention shown in FIG. 1 can be used for reproducing a packet interval in a TS transmitted in the packet mode. A packet transmission system according to a second embodiment of the present invention described later in FIG. 7 can be used for reproducing a packet interval in a TS transmitted in any of the packet mode and the burst mode.

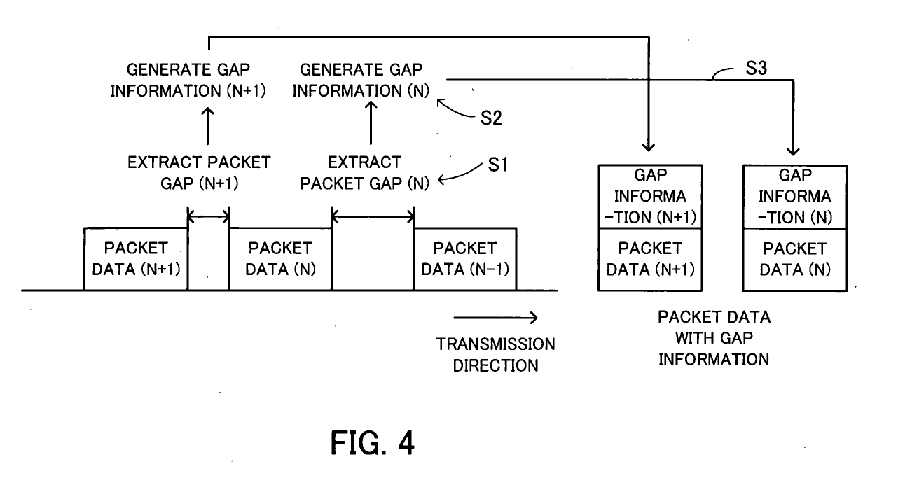

The operation of the packet sending unit 10 will now be described. FIG. 4 shows the operation of the packet sending unit 10.

[S1] The packet gap extraction section 11 extracts packet data (n−1) and a packet gap (n) between the packet data (n−1) and packet data (n) which reaches right after the packet data (n−1) from a TS it received.

[S2] The packet gap measurement section 12 counts the number of bytes corresponding to the packet gap (n) extracted and generates gap information (n).

[S3] The packet data with gap information sending section 13 adds the gap information (n) to the corresponding packet data (n) and generates and outputs packet data with gap information.

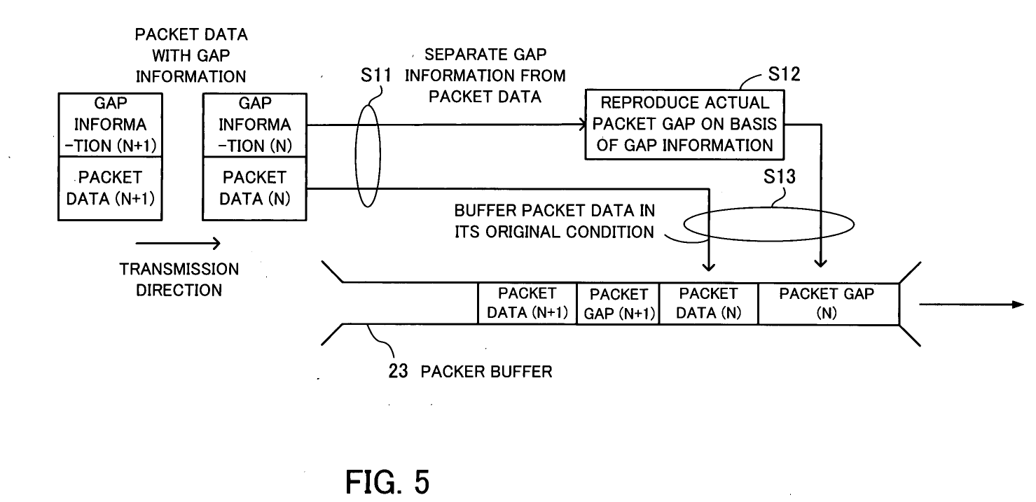

The operation of the packet receiving unit 20 will now be described. FIG. 5 shows the operation of the packet receiving unit 20. The operation of buffering in the packet buffer 23 performed in the case of packet gap adjustment not being made by the buffer monitoring section 24 is shown.

[S11] The packet data with gap information separation section 21 receives the packet data with gap information, separates the gap information from the packet data, and sends the gap information and the packet data to the packet gap insertion section 22 and the packet buffer 23 respectively.

[S12] The packet gap insertion section 22 reproduces the data length of the actual packet gap on the basis of the gap information.

[S13] The packet buffer 23 stores the packet data in its original condition. The packet buffer 23 also stores the packet gap reproduced by the packet gap insertion section 22.

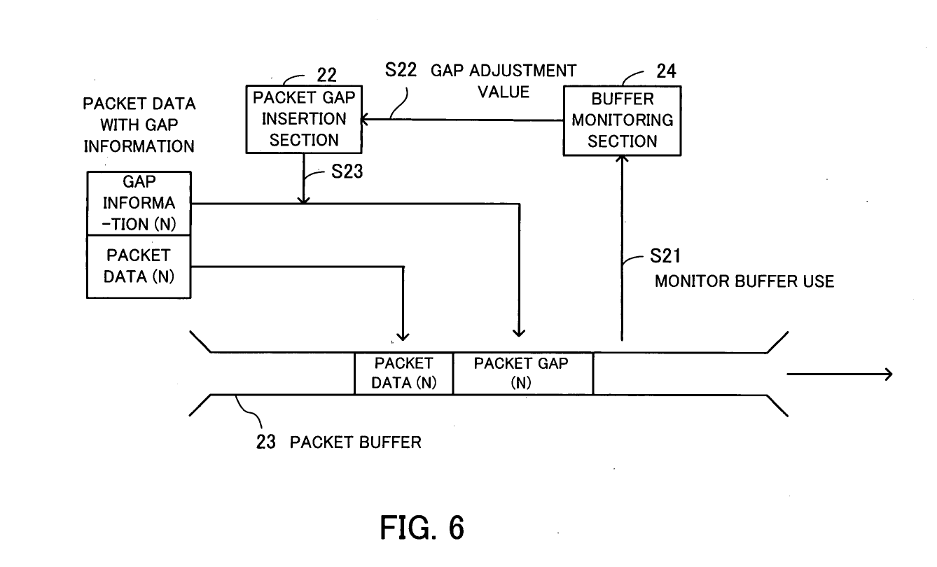

FIG. 6 shows the operation of the packet receiving unit 20. The operation of buffering in the packet buffer 23 based on a packet gap adjustment made by the buffer monitoring section 24 is shown.

After a certain amount of data is stored in the packet buffer 23, reading is begun. After that, reading is performed at any time.

Usually there is a clock deviation between sending-end and receiving-end units. Accordingly, if the clock deviation is not corrected, sooner or later an overflow or an underflow occurs in a buffer. That is to say, if (sending-end clock frequency in the packet sending unit 10)>(receiving-end clock frequency in the packet receiving unit 20), then an overflow occurs in the packet buffer 23. Conversely, if (sending-end clock frequency in the packet sending unit 10)<(receiving-end clock frequency in the packet receiving unit 20), then an underflow occurs in the packet buffer 23.

If there is no clock deviation between the sending and receiving units, the amount of data (packet data and packet gaps) stored in the packet buffer 23 is approximately constant. However, if a master clock in the packet receiving unit 20 is faster than a master clock in the packet sending unit 10, buffer use is smaller than a definite amount. If the master clock in the packet receiving unit 20 is slower than the master clock in the packet sending unit 10, buffer use is greater than the definite amount. Therefore, the buffer monitoring section 24 performs the following operation to keep buffer use constant. By doing so, the occurrence of an overflow or an underflow is prevented.

[S21] The buffer monitoring section 24 monitors buffer use at certain intervals.

[S22] If buffer use is greater than an overflow detection threshold, then the buffer monitoring section 24 sends the packet gap insertion section 22 a gap adjustment value for decreasing packet gap length by one (1 byte). If buffer use is smaller than an underflow detection threshold, then the buffer monitoring section 24 sends the packet gap insertion section 22 a gap adjustment value for increasing packet gap length by one (1 byte).

[S23] The packet gap insertion section 22 adjusts packet gap length on the basis of the gap adjustment value and inserts a packet gap the byte number of which is finely adjusted into packet data.

As has been described in the foregoing, by using the packet transmission system 1 according to the first embodiment of the present invention, a packet stream including a packet interval that is the same as a packet interval included in a packet stream received by the packet sending unit 10 can be outputted from the packet buffer 23 and be reproduced. In addition, the buffer monitoring section 24 always monitors the buffer state of the packet buffer 23 and finely adjusts packet gap length. This prevents an overflow or an underflow caused by clock deviation between the packet sending unit 10 and the packet receiving unit 20.

The packet transmission system according to the second embodiment of the present invention that is applicable to a TS transmitted in any of the packet mode and the burst mode which are DVB-ASI transmission formats will now be described. FIG. 7 shows the structure of the packet transmission system.

A packet transmission system 2 according to the second embodiment of the present invention comprises a packet sending unit 30 and a packet receiving unit 40 and make packet transmission by transferring a packet interval at the sending end to the receiving end. The packet transmission system 2 is applicable to the digital video transmission system 1a shown in FIG. 2.

The packet sending unit 30 includes an inter-timing gap extraction section 31, an inter-timing gap measurement section 32, and a packet data with inter-timing gap information sending section 33. The inter-timing gap extraction section 31 extracts an interval from first timing information included in nth packet data to second timing information included in (n+1)th packet data from a packet stream in which packet data including timing information is multiplexed as an inter-timing gap.

The inter-timing gap measurement section 32 measures the inter-timing gap extracted and generates inter-timing gap information which is a measured value. The packet data with inter-timing gap information sending section 33 adds the inter-timing gap information to the packet data and generates and sends packet data with inter-timing gap information.

The packet receiving unit 40 includes a packet data with inter-timing gap information separation section 41, an inter-timing gap buffer 42, a packet data buffer 43, an inter-timing gap buffer monitoring section 44, and a packet data reading section 45.

The packet data with inter-timing gap information separation section 41 receives the packet data with inter-timing gap information and separates the inter-timing gap information from the packet data. The inter-timing gap buffer 42 reproduces data length on the basis of the inter-timing gap information and stores it. The packet data buffer 43 stores the packet data.

The inter-timing gap buffer monitoring section 44 monitors buffer use of the inter-timing gap buffer 42. If the buffer use is greater than an overflow detection threshold, then the inter-timing gap buffer monitoring section 44 generates an inter-timing gap adjustment value for narrowing the inter-timing gap. If the buffer use is smaller than an underflow detection threshold, then the inter-timing gap buffer monitoring section 44 generates an inter-timing gap adjustment value for widening the inter-timing gap.

The packet data reading section 45 adjusts the inter-timing gap stored in the inter-timing gap buffer 42 on the basis of the inter-timing gap adjustment value. The packet data reading section 45 reads out the packet data from the packet data buffer 43 while setting an inter-timing gap adjusted.

The packet data reading section 45 exercises control so that the inter-timing gap buffer 42 and the packet data buffer 43 will always be synchronized. That is to say, an inter-timing gap stored in the inter-timing gap buffer 42 is associated with packet data stored in the packet data buffer 43.

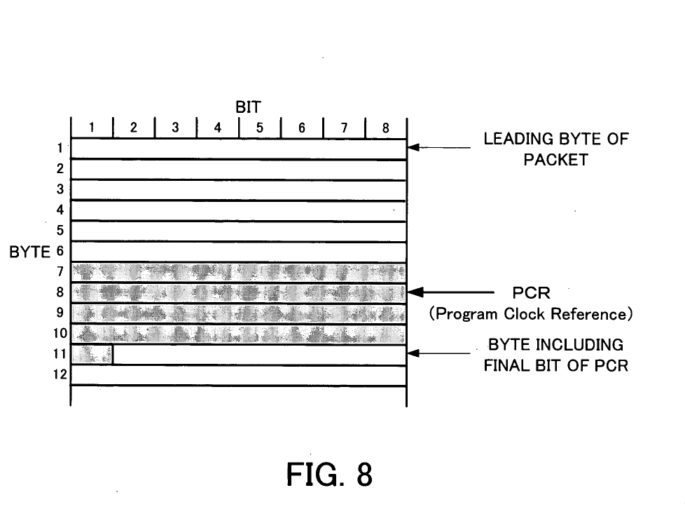

The position of timing information will now be described. FIG. 8 shows the position of timing information. DVB-ASI timing information is referred to as a program clock reference (PCR). A PCR is located in the seventh through eleventh bytes from the head of a packet.

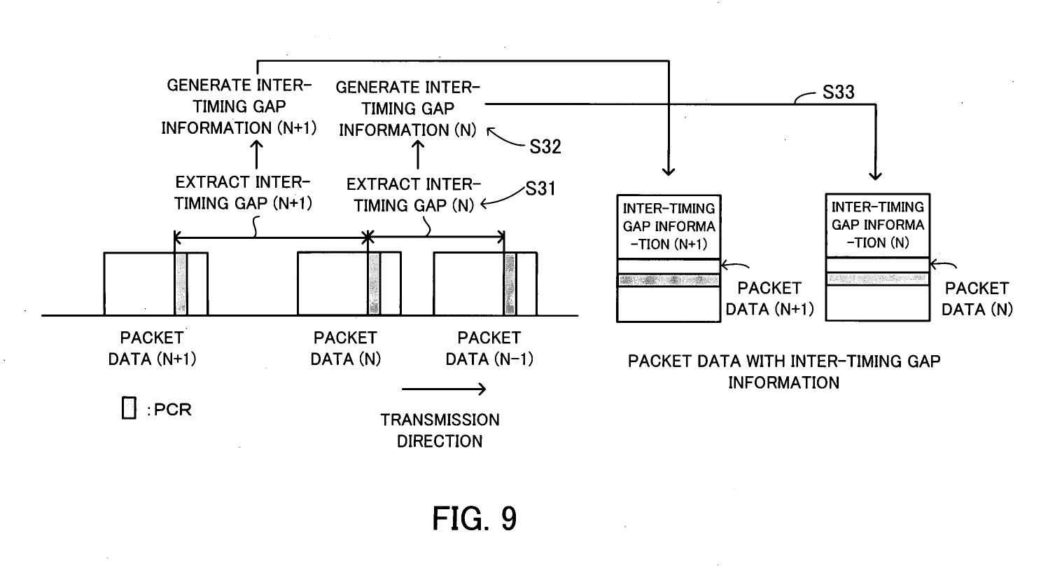

The operation of the packet sending unit 30 will now be described. FIG. 9 shows the operation of the packet sending unit 30.

[S31] The inter-timing gap extraction section 31 extracts an interval from the eleventh byte of a packet (n−1) including the final bit of a first PCR to the eleventh byte of a packet (n) including the final bit of a second PCR from a DVB-ASI TS in which packets each including a PCR as timing information are multiplexed as an inter-timing gap (n).

[S32] The inter-timing gap measurement section 32 counts the number of bytes included in the inter-timing gap (n) extracted and generates inter-timing gap information (n).

[S33] The packet data with inter-timing gap information sending section 33 adds the inter-timing gap information (n) to the corresponding packet data (n) and generates and outputs packet data with inter-timing gap information.

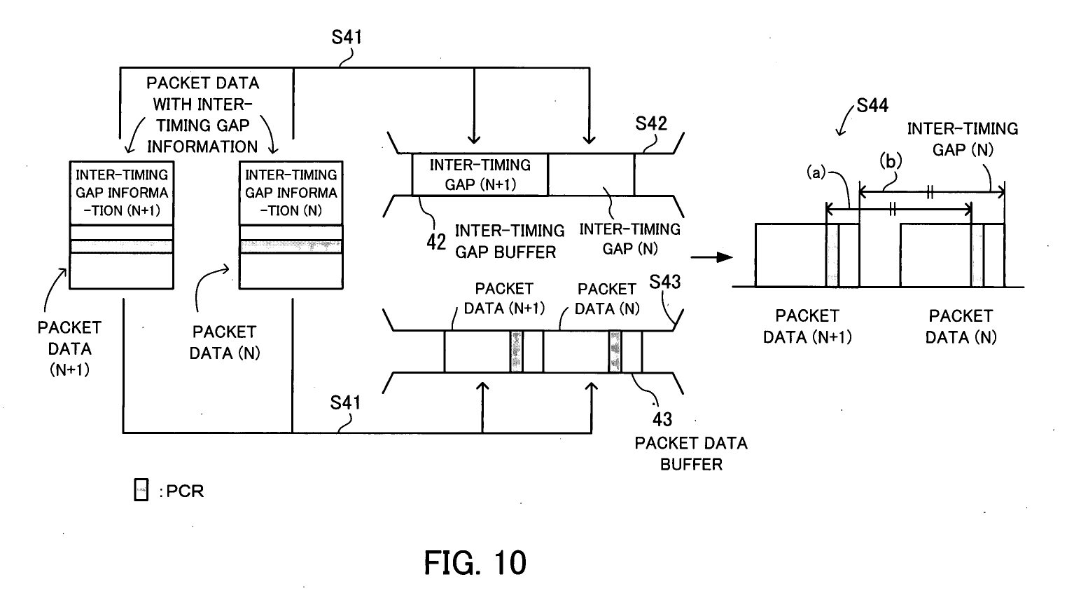

The operation of the packet receiving unit 40 will now be described. FIG. 10 shows the operation of the packet receiving unit 40. Packet data reading operation performed in the case of inter-timing gap adjustment not being made by the inter-timing gap buffer monitoring section 44 is shown.

[S41] The packet data with inter-timing gap information separation section 41 receives the packet data with inter-timing gap information, separates the inter-timing gap information from the packet data, and sends the inter-timing gap information and the packet data to the inter-timing gap buffer 42 and the packet data buffer 43 respectively.

[S42] The inter-timing gap buffer 42 reproduces data length (byte number) on the basis of the inter-timing gap information and stores it.

[S43] The packet data buffer 43 stores the packet data in its original condition.

[S44] The packet data reading section 45 reads out the packet data from the packet data buffer 43, while setting the inter-timing gap with the eleventh byte of the packet data including the final bit of the PCR as reference. Alternatively, the packet data reading section 45 reads out the packet data from the packet data buffer 43, while setting the inter-timing gap with the head of the packet data as reference.

As shown in FIG. 10, the TS is reproduced by (a) setting the inter-timing gap with the eleventh byte of the packet data including the final bit of the PCR as reference or (b) setting the inter-timing gap with the head of the packet data as reference.

It is assumed that the TS is reproduced by (b). If the original TS is transmitted in the packet mode, it is clear that an interval between the PCR included in the packet data (n−1) in the TS and the PCR included in the packet data (n) in the TS can be reproduced by the inter-timing gap (n). It is assumed that the original TS is transmitted in the burst mode. The output mode of the packet sending unit 30 is not the burst mode, but the packet mode. Accordingly, there is no problem about reproducing the TS by (b). The interval between the PCR included in the packet data (n−1) and the PCR included in the packet data (n) can be reproduced. That is to say, in the packet receiving unit 40 either of (a) and (b) can be used for reproducing a TS on the basis of an inter-timing gap.

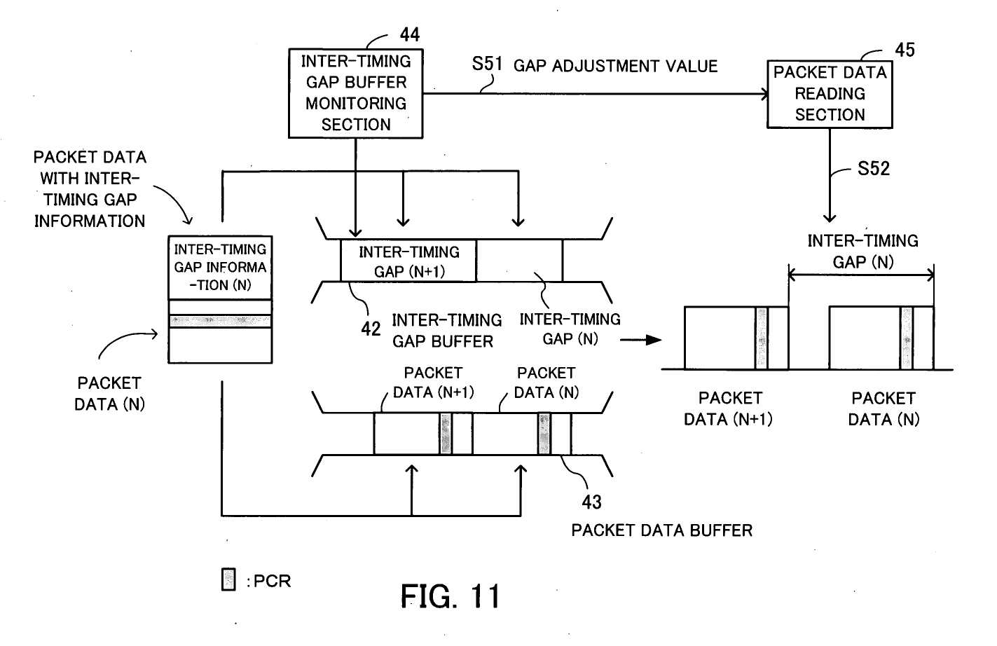

FIG. 11 shows the operation of the packet receiving unit 40. Packet data reading operation based on an inter-timing gap adjustment made by the inter-timing gap buffer monitoring section 44 is shown.

[S51] The inter-timing gap buffer monitoring section 44 monitors the buffer use of the inter-timing gap buffer 42. If the buffer use is greater than the overflow detection threshold, then the inter-timing gap buffer monitoring section 44 generates an inter-timing gap adjustment value for reducing the length of the inter-timing gap by one (1 byte).

If the buffer use of the inter-timing gap buffer 42 is smaller than the underflow detection threshold, then the inter-timing gap buffer monitoring section 44 generates an inter-timing gap adjustment value for increasing the length of the inter-timing gap by one (1 byte).

[S52] The packet data reading section 45 finely adjusts the inter-timing gap (n) stored in the inter-timing gap buffer 42 on the basis of the inter-timing gap adjustment value generated in step S51.

To reproduce the TS, the packet data reading section 45 reads out the packet data (n) from the packet data buffer 43 while setting the inter-timing gap finely adjusted with, for example, the head of the packet data as reference.

The following method may be used for reproducing the TS. A packet gap is calculated by the data length of the packet data (n) stored in the packet data buffer 43 from the data length of the inter-timing gap finely adjusted (inter-timing gap length−packet data length=packet gap). The packet data reading section 45 reads out the packet data from the packet data buffer 43 while inserting the packet gap (idle data) calculated.

In the present invention, as has been described in the foregoing, an overflow or an underflow in the receiving-end buffer can be prevented and a packet interval at the sending end can be reproduced with great accuracy at the receiving end. This applies in the packet mode and the burst mode in either of which a DVB-ASI signal is transmitted. As a result, distortion of video or audio which occurs when the sending end does not synchronize with the receiving end can be eliminated.

The packet sending unit included in the packet transmission system according to the present invention extracts a packet gap from a packet stream, measures the packet gap and generates gap information, and generates and sends packet data with gap information. The packet receiving unit included in the packet transmission system according to the present invention generates a gap adjustment value used for narrowing the packet gap in the case of the buffer use of the packet buffer being greater than an overflow detection threshold or used for widening the packet gap in the case of the buffer use being smaller than an underflow detection threshold and inserts a packet gap adjusted on the basis of the gap adjustment value into packet data to be buffered. As a result, the occurrence of an overflow or an underflow is prevented and a packet interval at the sending end is reproduced with great accuracy at the receiving end. Therefore, high-quality packet transmission can be performed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A packet transmission system for transmitting a packet, the system comprising:
a packet sending unit including:
a packet gap extraction section for extracting a packet gap from a packet stream in which packet data is multiplexed,
a packet gap measurement section for measuring the packet gap extracted and for generating gap information which is a measured value, and
a packet data with gap information sending section for adding the gap information to the packet data and for generating and sending packet data with gap information; and
a packet receiving unit including:
a packet data with gap information separation section for receiving the packet data with gap information and for separating the gap information from the packet data,
a packet gap insertion section for inserting a packet gap adjusted on the basis of a gap adjustment value into the packet data to be buffered,
a packet buffer for storing the packet data and the packet gap inserted, and
a buffer monitoring section for monitoring buffer use of the packet buffer and for generating the gap adjustment value used for narrowing the packet gap in the case of the buffer use being greater than an overflow detection threshold or used for widening the packet gap in the case of the buffer use being smaller than an underflow detection threshold.

2. A packet transmission system for transmitting a packet, the system comprising:
a packet sending unit including:
an inter-timing gap extraction section for extracting an interval from first timing information included in nth packet data to second timing information included in (n+1)th packet data from a packet stream in which packet data including timing information is multiplexed as an inter-timing gap,
an inter-timing gap measurement section for measuring the inter-timing gap extracted and for generating inter-timing gap information which is a measured value, and
a packet data with inter-timing gap information sending section for adding the inter-timing gap information to the packet data and for generating and sending packet data with inter-timing gap information; and
a packet receiving unit including:
a packet data with inter-timing gap information separation section for receiving the packet data with inter-timing gap information and for separating the inter-timing gap information from the packet data,
an inter-timing gap buffer for storing an inter-timing gap having data length corresponding to the inter-timing gap information,
a packet data buffer for storing the packet data,
an inter-timing gap buffer monitoring section for monitoring buffer use of the inter-timing gap buffer and for generating an inter-timing gap adjustment value used for value for narrowing the inter-timing gap in the case of the buffer use being greater than an overflow detection threshold or used for widening the inter-timing gap in the case of the buffer use being smaller than an underflow detection threshold, and
a packet data reading section for adjusting the inter-timing gap stored in the inter-timing gap buffer on the basis of the inter-timing gap adjustment value and for reading out the packet data from the packet data buffer while setting an inter-timing gap adjusted.

3. The packet transmission system according to claim 2, wherein the inter-timing gap extraction section extracts an interval from a byte of an nth packet including a final bit of a first program clock reference to a byte of an (n+1)th packet including a final bit of a second program clock reference from a DVB-ASI transport stream in which packets each including a program clock reference as the timing information are multiplexed as the inter-timing gap.

4. The packet transmission system according to claim 2, wherein the packet data reading section reads out the packet data from the packet data buffer by setting the inter-timing gap with a head of the packet data as reference or by setting the inter-timing gap with the timing information included in the packet data as reference.
